(19) United States
(12) Patent Application Publication
(10) Pub. No.: US 2009/0150860 A1
(43) Pub. Date: Jun. 11, 2009

(54) METHOD AND SYSTEM FOR COMBINING QUALITY ASSURANCE AND MODEL TRANSFORMATIONS IN A BUSINESS-DRIVEN DEVELOPMENT ENVIRONMENT

(75) Inventors: Thomas Gschwind, Zurich (CH); Jana Koehler, Oberrieden (CH); Jochen M. Kuester, Zurich (CH); Ksenia Ryndina, Zurich (CH); Jussi H. Vanhatalo, Zurich (CH); Hagen Voelzer, Zurich (CH)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/953,971

(22) Filed: Dec. 11, 2007

(51) Int. Cl. G06F 9/44

(52) U.S. Cl. 717/104

(57) ABSTRACT

A system for combining quality assurance and model transformations in a business-driven development environment includes a host system executing a business modeling application, a transformation framework including a transformation programming interface (TPI) and a quality assurance framework executing on top of the business modeling application, and a plurality of transformation plug-in tools in communication with the TPI. The TPI includes options for model access and traversal, model element creation/removal, model element property editing and analysis. The options are applied to the transformations, via the selected transformation plug-in tools, to a business model resulting in a modified business model that conforms to an information technology (IT)-based executable code. The quality assurance framework performs single-entry-single-exit (SESE) fragment decomposition of the modified business model, control-flow analysis, and notification to the user of any detected error conditions, the notification presented to the user with the modified business model via the TPI.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to business process modeling, and particularly to a method and system for combining quality assurance and model transformations in a business-driven development environment.

2. Description of Background

Traditionally, the models of a business process and its implementation in an information technology (IT) system are considered separate artifacts. A business process model, in the best case, serves as documentation for the implemented system. However, since business process models and their implementation evolve independently, they can quickly become inconsistent with each other.

Today, increasing pressure from regulations, combined with opportunities from new technologies (such as those related to Service-Oriented Architecture (SOA)), require models to reflect the reality of the implemented business processes. Furthermore, IT implementations should be derived more directly from business needs, which is often referred to as business-driven development. Consequently, modeling tools increasingly address the transition from business to information technology (IT) and vice versa. There are two significant trends associated with this transition. On the one hand, quality assurance strives to enable users to create business process models of higher quality from which correct, executable code can be obtained in a lean development process. On the other hand, model transformations aim at automating the transition across the semantic gap between business and IT. Both trends reflect the need to make modeling a less heavyweight activity with the vision of moving towards more agile modeling tools where users can quickly respond to changes in processes and systems, obtain immediate feedback on the quality of the models, and receive help to build software from models in shorter iterations.

The need to constantly adapt and revise process models due to unforeseeable changes leads to an increased interest in providing users with pre-implemented model transformations that enhance the usability of the modeling tools and the productivity of the user. For example, many of the business-level modeling tools available today allow users to generate part of the implementation on the basis of the modeled processes. This may include the generation of Web service descriptions, usually represented in the Web Service Description Language (WSDL), and of the corresponding service orchestrations represented in the Business Process Execution Language (BPEL). Many process modeling tools give a lot of freedom to business analysts, which may even include the definition of their own extensions to the modeling language. The interpretation of such extensions often lies with the user and is, thus, not accessible to the modeling tool, making code generation difficult or even impossible. Furthermore, technical details that are required at the IT level are usually missing in models drawn by business analysts.

To address this business-IT gap, modeling tools have begun to constrain business users by imposing a service-oriented and more technical modeling style so that technical details must be added to the models in a refinement step. Frequently, however, business analysts have difficulties in providing this kind of information. This typically requires a tool-supported handshake between business and IT that is not yet very well understood. This handshake comprises a continuum where a high-level business process model is refined to a design model and then further into executable code. To develop and provide the necessary refinement, refactoring, and abstraction operations in a modeling tool, a model transformation framework is needed that is seamlessly integrated into the modeling tool's architecture.

### SUMMARY OF THE INVENTION

The shortcomings of the prior art are overcome and additional advantages are provided through the provision of a system for combining quality assurance and model transformations in a business-driven development environment. The system includes a host system executing a business modeling application, a transformation framework including a transformation programming interface (TPI) and a quality assurance framework executing on top of the business modeling application, and a plurality of transformation plug-in tools in communication with the TPI. The TPI includes options for model access and traversal, model element creation/removal, model element property editing and analysis. The options are applied to the transformations, via the selected transformation plug-in tools, to a business process model resulting in a modified business process model that conforms to an information technology (IT)-based executable code. The quality assurance framework performs single-entry-single-exit (SESE) fragment decomposition of the modified business process model, control-flow analysis, and notification to the user of any detected error conditions, the notification presented to the user with the modified business process model via the TPI.

Methods and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which provides transformations that are easily applicable by business users to automate complicated editing steps. These transformations are linked to quality assurance capabilities provided in modeling tools, such that the transformations can be made “intelligent” and help users to preserve or re-establish the correctness of their models when going through a sequence of refinement and refactoring operations. The set of implemented transformations may significantly increase user productivity as they raise the abstraction level of the model-editing palette from a “picture drawing” tool to a level that supports real business process modeling.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a conventional process model;

FIG. 2 illustrates one example of a model transformation that joins the parallel branches of the process model of FIG. 1 via model transformation processes in an exemplary embodiment of the invention;

FIG. 3 illustrates one example of a second model transformation which merges a newly introduced stop node of FIG. 2 with two existing stop nodes ending the exclusive branches of the process model, implemented via model transformation processes in an exemplary embodiment; and

FIG. 4 illustrates one example of the process model resulting from the model transformation processes of FIGS. 2 and 3, and its SESE fragments, in an exemplary embodiment of the invention; and

FIG. 5 illustrates one example of a system architecture for implementing the model transformation processes in an exemplary embodiment.

The detailed description explains the preferred embodiments of the invention, together with advantages and features, by way of example with reference to the drawings.

### DETAILED DESCRIPTION OF THE INVENTION

In accordance with an exemplary embodiment, model transformation processes are provided. The model transformation processes may be implemented using a model transformation framework as described further herein. The model transformation processes are performed in conjunction with a business process modeling tool. For purposes of illustration, the model transformation processes are implemented in conjunction with IBM® WebSphere Business Modeler™, an Eclipse®-based commercial product for business process modeling and analysis.

The model transformation processes provide the capability to accommodate a wide spectrum of transformations during business-driven development, as well as combine model transformations with quality assurance. Quality assurance may be particularly important when transforming models describing complex behavior, because errors such as deadlocks only occur in behavioral models, and not in static models such as class diagrams. Quality assurance usually requires that the pre- and post-conditions of a transformation involve a very elaborate model analysis.

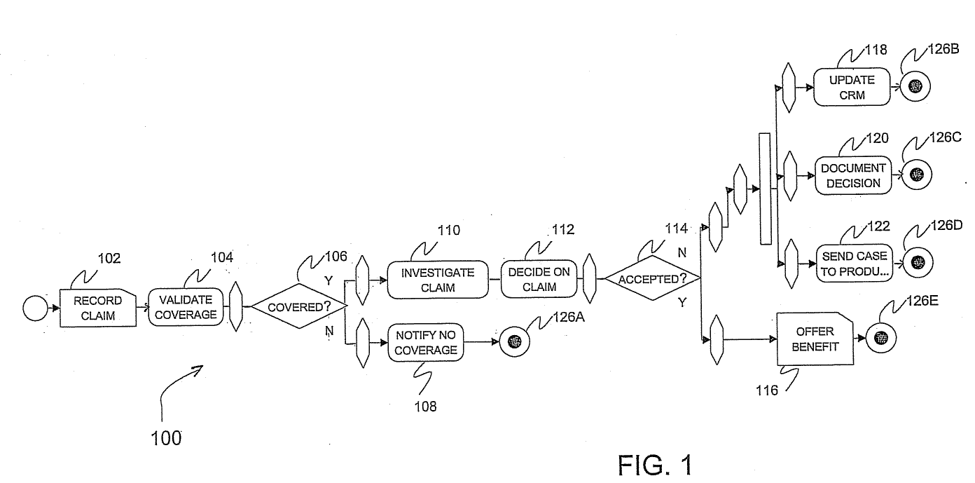

A business process model 100 of a business process as captured by a business analyst is shown in FIG. 1. By way of example, the process model 100 describes a simplified flow directed to claims handling by an insurance company. As shown in FIG. 1, a claim is recorded (102), followed by a subprocess during which the coverage of the claim by the insurance policy of the customer is validated (104). If the customer has no coverage (106), then she is simply notified of this fact (108). Otherwise, the company continues to investigate whether the claim can be accepted (110), and a decision is rendered (112). If the claim is accepted (114), a subprocess to offer a benefit is entered (116), which leads to the final settlement of the claim. If the claim is rejected (114), three activities take place in parallel: information in the Customer Relationship Management system (CRM) is updated to inform the customer about the rejection (118), the decision is documented (120), and the case is sent to product development (122).

It will be understood by those skilled in the art that the control flow illustrated in FIG. 1 is simplified and omits many details of the process such as the data that is involved in the activities and the organizations responsible for various activities in the process. As shown in the model 100, two decisions, ‘Covered?’ 106 and ‘Accepted?’ 114, lead to exclusive choices in the process flow. In case the claim is covered, but rejected, the process forks into a parallel process fragment 124 containing three activities 118, 120, and 122. Thus, this control flow leads in total to five branches in the process model, which consist of a mixture of sequential and parallel execution threads. Each branch ends individually with a single stop node 126A-126E. As soon as one of these stop nodes 126 is reached, the entire process would terminate immediately. This can lead to problems for activities in the process that are executed in parallel as they may not have completely finished when a stop node terminates the process. Although this termination behavior was probably not intended by the business analyst drawing the process model, it can often be observed in real-world process models where it is caused by a modeling practice of not re-joining parallel branches.

In the IT implementation process, this modeling problem should be corrected. The BPEL process must end with a single reply followed by a single stop node to provide the result of the process back to the invoking service.

For example, BPEL code (adopting a “link style”) generated from the business process model, using a join condition that combines these five links (branches) at the reply, is associated with the correct AND logic for links associated with activities 118, 120, and 122, combined with the XOR logic for links associated with activities 108 and 116. Automatically deriving the correct join condition requires analysis of the control flow of the process model 100. A BPEL code using a “block-style” may alternatively be employed whereby explicit switch activities are used for the two exclusive decisions and a flow activity encapsulating the three parallel process steps in case the claim is rejected. This notational variant makes the BPEL flow logic more readable. In this variant, an analysis of the process model 100 is performed to determine the scope for the switch and flow activities of the process.

In either style, both BPEL versions result in a slightly changed process model at the IT level, which corrects the termination behavior of the business process model 100. Thus, the business process model 100 is no longer consistent with its implementation. Ideally, changes that have been applied during the business-to-IT transition should be reflected at the business level. One possibility is to recompute the business process model 100 as an abstract view on the BPEL code. However, this leads to two different process models, one drawn by the business analyst and the other generated from the IT process, which need to be synchronized again. Another possibility is to use the business process model 100 as input into a business-driven development process where transformations are iteratively applied until a design model is obtained from which BPEL code can be directly generated. The model transformation processes address the issue using the second scenario as described further herein.

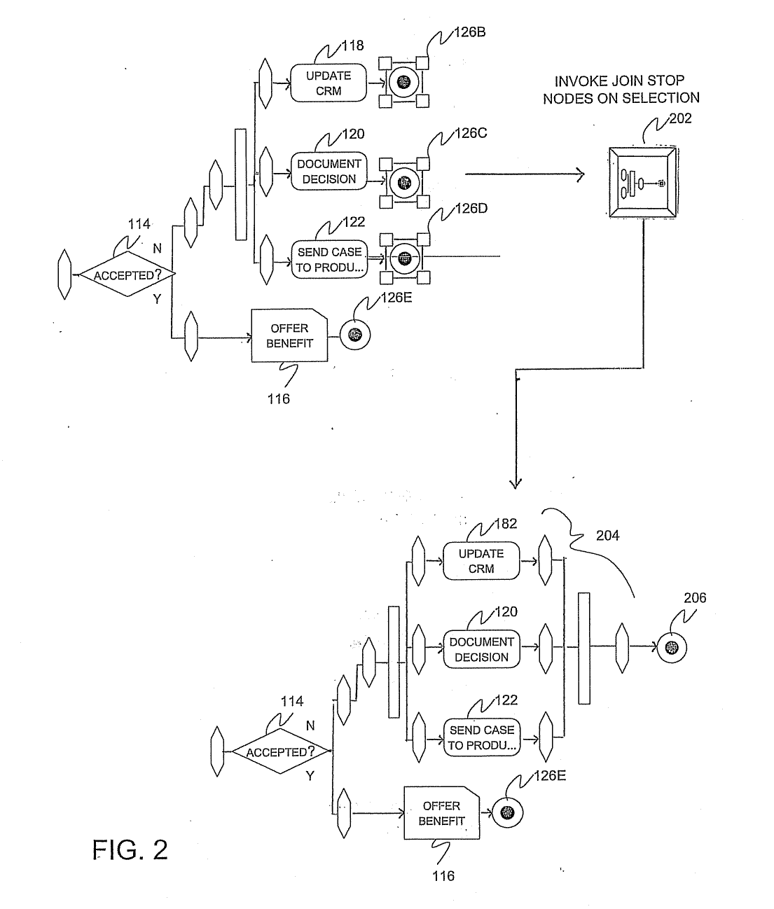

The model transformation processes assume that a developer (user) wishes to apply transformations to the business process model (e.g., model 100) of the business process in order to obtain a process design that reflects the desired BPEL block structure. The model transformation processes are configured to inform the user that the model contains sequential and parallel branches that end in individual stop nodes. Then, it may either automatically apply transformations to make the model structurally aligned to the future BPEL or guide the user in applying the appropriate transformations. FIG. 2 illustrates a first possible model transformation that joins the parallel branches (i.e., associated with activities 118, 120, and 122) of the process model 100 using a ‘join stop node’ transformation 202. That is, it takes the three stop nodes 126B-126D ending the branches in the parallel process fragment and replaces them by a join 204, followed by a single stop node 206.

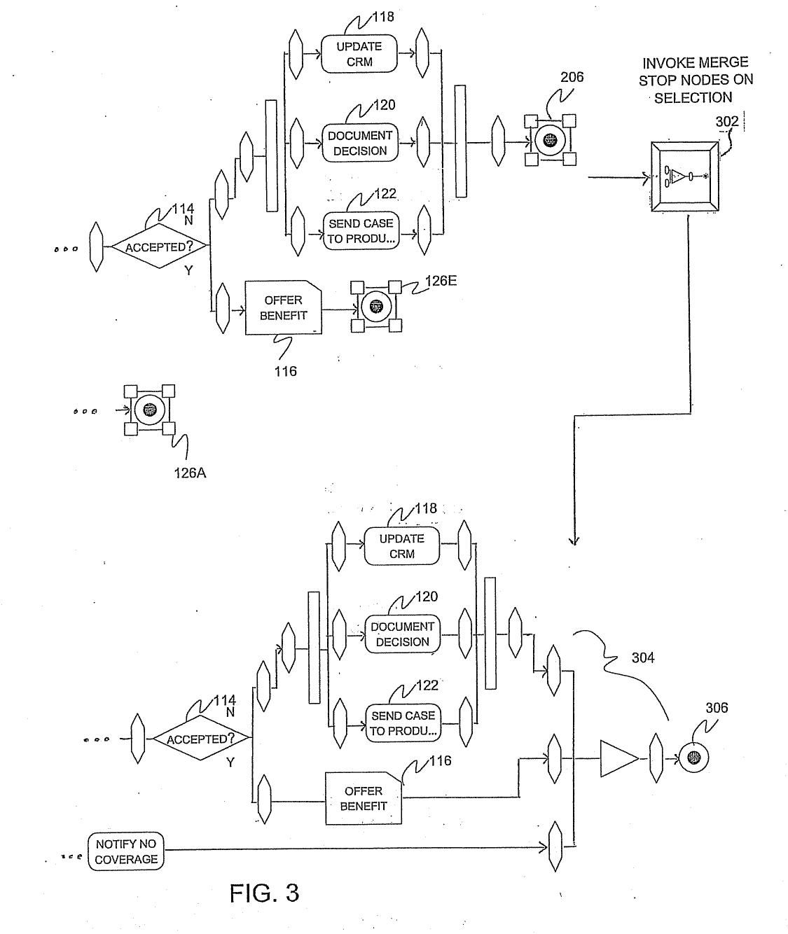

In a second transformation, the newly introduced stop node 206 is merged with the two stop nodes 126A and 126E ending the exclusive branches using a ‘merge stop node’ transformation 302, as shown in FIG. 3. A merge 304 is introduced followed by a single stop node 306. This yields the desired BPEL block structure, from which also the correct join condition for link-style BPEL code can be easily computed. These transformations result in what is referred to herein as a modified business process model.

If the user had applied a join to a larger selection of stop nodes, an incorrect process model would result that does not correctly terminate. The model transformation processes will warn or prevent the user from applying transformations that lead to an incorrect model. The structural analysis methods used to ensure that users obtain feedback about the correctness of models resulting from a transformation will now be described.

Obtaining a faithful and error-free executable model can be a difficult and painful task. Business process models can be quite complex, often comprising a hundred or more activities with complex interactions between various business partners. Applying transformations to such a complex model can easily give rise to the introduction of additional errors when done manually. It is thus important that a transformation framework can evaluate the quality, and in particular, the correctness of a model before a transformation is applied. Furthermore, there should be something like a look-ahead (if applying a transformation to a correct model yields an incorrect model, the user must be made aware of this issue).

Possible errors in business process models include control-flow and data-flow errors. An example of a control-flow error is a deadlock, i.e., a situation where some part of the process is waiting indefinitely for another part of the process. A data-flow error occurs, e.g., when a piece of data is not available when needed. Many of these errors can be avoided by applying a rigorous modeling discipline, i.e., by using correct modeling patterns and avoiding modeling anti-patterns.

Control-flow and data-flow errors can also be detected automatically by dedicated analysis algorithms. Detection of deadlocks or a wider class of errors can be done using techniques from the area of model checking which can be applied to business process models. In the worst case, these techniques have to build the whole state space of the process model the size of which can be exponential in the size of the process model, a problem that is widely known as state space explosion. To mitigate the state space explosion problem, the model transformation processes use a technique that decomposes the process model into a hierarchy of single-entry-single-exit (SESE) fragments (e.g., in a manner similar to that used in compiler theory).

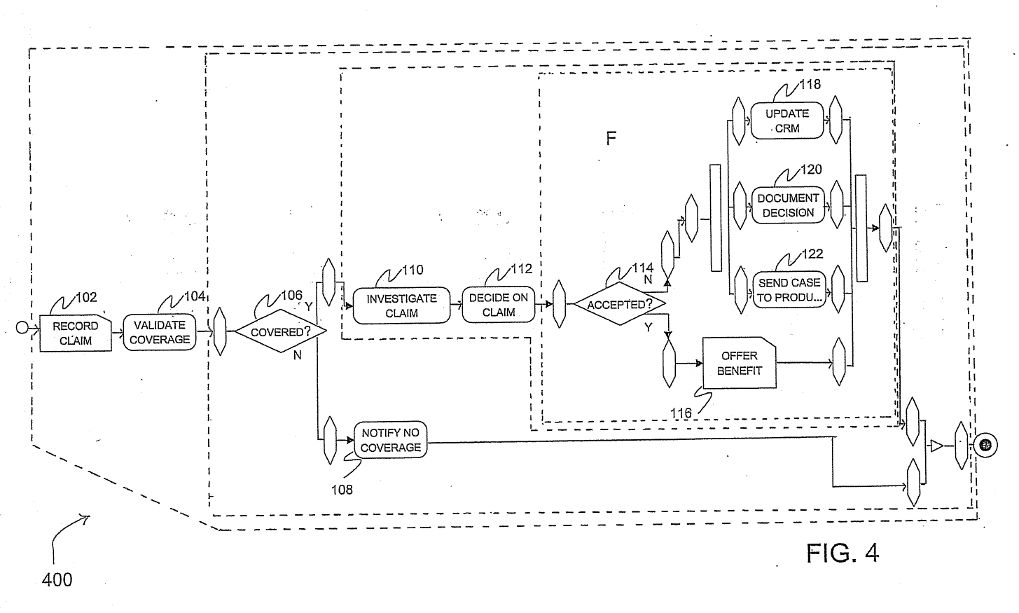

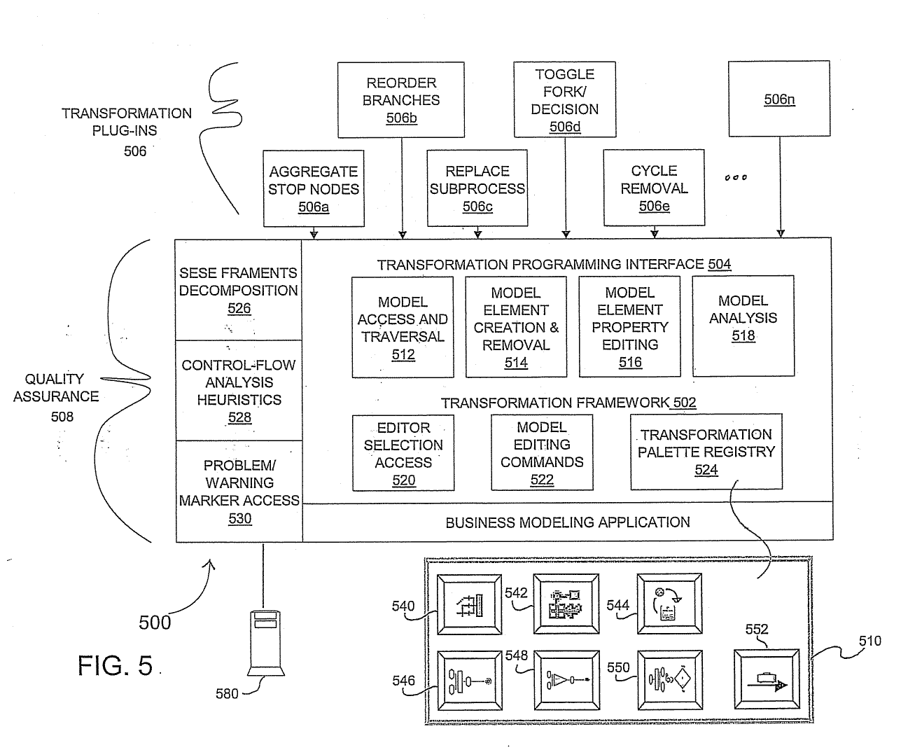

FIG. 4 shows a process model 400 resulting from the activities described in FIGS. 2 and 3, and its SESE fragments, which are illustrated as four dashed boxes. In contrast to FIG. 2, the Join Stop Nodes transformation was applied in FIG. 4 joining the four stop nodes 126B-E from FIG. 1. This application of the transformation introduces a deadlock in the process model of FIG. 4, while the application of the same transformation to only three stop nodes shows a deadlock-free model in FIG.2. The deadlock in FIG.4 occurs in case the claim is accepted, because the join 204 in fragment F waits in vain for the other three activities 118, 120, and 122 in fragment F to finish. The model transformation processes implement this fragmentization via a quality assurance feature 508 (see, e.g., SESE fragments decomposition component 526 of FIG. 5).

In order to check for control-flow errors in the overall process model 400, it is sufficient to check each fragment in isolation, i.e., each error is local to some SESE fragment. For example, the deadlock in FIG. 4 is local to fragment F.

A SESE fragment is usually much smaller than the overall process. Its size is measured as the number of edges between its direct subfragments. Since the decomposition into SESE fragments can be computed in linear time and there are at most twice as many fragments than atomic activities in the process model, the time used for the control-flow analysis of all the fragments mainly depends on the size of the largest fragment in the process.

As a second technique to mitigate the state space explosion problem, heuristics may be applied in linear time to sort out many of the error-free (and a fair amount of the erroneous) fragments before any state space generation is applied. They may be based on the observation that many error-free, and some erroneous fragments, in practice have a simple structure that can be recognized easily. For example, the deadlock in fragment F in FIG. 4 can be detected by recognizing that the fragment includes a decision, but no merge. The model transformation processes implement this control-flow analysis/heuristics via the quality assurance feature 508 (see, e.g., control-flow analysis heuristics component 528 in FIG. 5).

Modeling errors are reported to the user who can then take steps to correct the model by manually editing the model or applying automatic transformations. When interleaving the analysis with model transformations, the user can be warned that the selected transformation is not applicable to the set of selected stop nodes without introducing a deadlock into the model. The model transformation processes implement these reporting activities via the quality assurance feature 508 (see, e.g., problem/warning marker access component 530 in FIG. 5). The analysis results are also used by the transformation framework to modify the set of model elements to which a transformation can be correctly applied. In the example, the Join Stop Nodes transformation could be applicable to a smaller set of selected stop nodes without introducing a deadlock into the model. The modified selection can be shown to the user for approval and execution. If no smaller selection exists, the transformation informs the user that it is not applicable.

Turning now to FIG. 5, an exemplary system upon which the model transformation processes may be implemented will now be described. The system of FIG. 5 includes a host system 580 executing a business modeling application 500. The business modeling application 500 may be, e.g., IBM's® WebSphere Business Modeler™ running on top of the IBM® Eclipse™ platform. For illustrative purposes, the framework of the business modeling application 500 is designed using the model-view-controller pattern and that it is possible to manipulate the model elements using the command pattern. Unfortunately, the command pattern does not support easy programmatic access of a model. For example, for every change, a command object has to be setup with the correct parameters, options, and references to the model elements to be modified. With this approach, most of the transformation code would be dedicated to setting up commands and pushing them onto the command execution stack, and the logic of the transformation would become very hard to follow.

Thus, an abstraction layer (e.g., transformation programming interface (TPI) 504, transformation framework 502, and quality assurance feature 508) is provided by the model transformation processes to enable programmatic access to in-memory models so that they may be modified with minimal amount of coding, but still without breaking the model-view-controller design of the business modeling application 500. This way, the results of a transformation become immediately visible to the user, while for the developer, the elements of a model are exposed in such a way that it becomes easy to implement transformations using an ordinary programming language, i.e., Java™. In this approach, transformations may be natively executed as no interpretation is required, and the Eclipse® infrastructure, e.g., may be reused to package and ship transformation plug-ins as extensions to the business modeling application 500.

The transformation framework 502 of the model transformation processes provides such an abstraction layer. It supports the execution of automatic refactoring, refinement, and abstraction transformations and enables their fall integration with the existing modeling environment and the quality assurance functionality. As shown in FIG. 5, by way of non-limiting example, the transformation framework 502 extends the business modeling application 500 environment, acting as a container of plug-ins 506a-506n, that package the actual transformation code so that the model transformation processes can be customized by activating and deactivating the appropriate transformation plug-ins 506a-506n. The transformation framework 502, as well as the quality assurance feature 508 execute on top of the business modeling application 500.

In an exemplary embodiment, the model transformation processes may be implemented via the TPI 504, which is visible to the developer. The TPI 504 is configured to ensure that process models are efficiently accessible for traversal, analysis, and modification by the transformation code.

A TPI table, shown below, the transformation framework 502, and the quality assurance feature 508 of FIG. 5, collectively summarize some of the features of the TPI 504 that help in the rapid development of new transformations. Transformations may use the interface 504 to edit models by creating new elements and removing existing ones via a model element creation and removal component 514. Element properties can be directly modified, e.g., to rename an element or to reposition an element in the diagram via a model element property editing component 516. Furthermore, the programming interface 504 is configured to support different patterns of model traversal via a model access and traversal component 512. Simple transformations are independently applied once to each target model element and thus do not require the transformation code to deal with model traversal issues. Complex transformations may require filtering of the elements of a model based on some criteria. In the simplest case, the filtering checks the element type, for example, in order to distinguish stop nodes from start nodes. However, non-trivial conditions may also be required, such as checking whether elements are connected or belong to a SESE fragment. These activities may be facilitated by a model analysis component 518 of the TPI 504 with the model analysis component 518 communicating with the quality assurance framework 508.

In general, transformations may traverse model elements in some specific order, for example, by drilling down the element containment structure or by navigating through the predecessor/successors elements as linked by the control flow. To support this kind of multi-pass transformations, the model transformation processes framework 502 provides transformations with random access to the model elements by a look up based on unique identifiers, e.g., via the model access and traversal component 512. The above components 512, 514, 516, and 518 are supported by the transformation framework 502 via an editor selection access component 520 and a modeling editing commands component 522 thereof. Finally, transformations can be registered with a palette or menu of macro editing buttons 510 via a transformation palette register 524 of the transformation framework 502, which are displayed to the user. This palette 510 is shown in FIG. 5.

As indicated above, a TPI table illustrates features enabled by the TPI 504, as shown below:

TABLE 1

| TPI Feature | Example command |
|---|---|
| Creation of new model elements | addStopNode( ) |
| | addStartNode( ) |
| | addTask( ) |
| | addGateway(Type) |
| | addControlEdge( ) |
| | addDataEdge(Type) |
| Removal of existing model elements | remove(Element) |
| Editing of model element properties | move(Position) |
| | rename(String) |
| Random access to model elements | find(ElementID) |
| Access to selected model elements | selection.getEdges( ) |
| | selection.getNodes( ) |
| | selection.getStopNodes( ) |
| Traversal of related model elements | getInBranch( ) |
| | getOutBranch( ) |
| | getPredecessor( ) |
| | getSuccessor( ) |
| | getParent( ) |
| | getChildren( ) |
| Analysis of model elements | isDisconnected( ) |
| | isSESE(Fragment) |
| Transformation palette registration | register(Transformation) |
| | unregister(Transformation) |

To illustrate how the TPI 504 can be used, a “stop node aggregation” transformation process implemented by the aggregate stop nodes component 504a will now be described. This transformation is applied to a set of selected stop nodes and replaces them with a join or merge depending on the user's input, as previously described in FIGS. 2 and 3.

```
transformation aggregateSelectedStopNodes(gatewayType) (
  predecessors = [ ];
  nodes = TPI.selection.getStopNodes( );
if (nodes.length > 1) (
  foreach (node in nodes) (
    predecessors.append(TPI.getPredecessor(node));
    TPI.remove(node);
  )
  gateway = TPI.addGateway(gatewayType, predecessors.length);
  stopNode = TPI.addStopNode( );
  TPI.addControlEdge(TPI.getOutBranch(gateway,0), stopNode);
  i = 0;
  foreach (pred in predecessors) (
      TPI.addControlEdge(pred, TPI.getInBranch(gateway,i));
      i++;
  )))
```

As shown in the above pseudo-code, the transformation first ensures that more than one stop node has been selected. As an additional precondition, the transformation could check whether aggregating the selected nodes would not introduce an error. Then, the transformation iterates over all selected stop nodes, stores their predecessor element for later use, and subsequently deletes the stop node. Then it adds either a join or a merge to the model and links its outgoing branch with a new stop node. The join or merge is provided as an argument to the transformation. Whether a join or a merge must be provided is determined using the quality assurance framework 508, which performs a control-flow analysis of the fragment containing the selected stop nodes. As a last step, it connects each predecessor element to a different incoming branch of the newly added join or merge.

As indicated above, transformations may be made available to users through a menu or palette 510. The palette 510 may be provided to users with transformations supporting certain development methodologies or industry-specific requirements. FIG. 5 shows a possible design of such a palette-based user interface. Users may invoke transformations via a menu or by clicking on a palette button/icon showing a mnemonic picture of the transformation. If no model elements are selected prior to invocation, a transformation may be applied to the whole model by default.

The palette 510 shows some of the model transformations that may be implemented via the model transformation processes. Most of these transformations may exist in a simple form without linking to quality assurance and in a more sophisticated form that links to quality assurance to support the user in correctly applying a transformation. In the upper row of the palette 510, (from left to right) the transformations include automatically reorder branches 540, replace subprocess 542, and cycle removal 544. In the lower row, the transformations join stop nodes 546, merge stop nodes 548, toggle fork/decision 550, and assign data container 552 are illustrated. In addition to these transformations, many others can be imagined.

Automatically reorder branches 540 is a horizontal, non-destructive, semantics preserving transformation that simply cleans up clutter in the diagram, which can occur when branches are connected to a join or merge. The transformation analyzes the graphical layout and eliminates crossing branches.

Replace subprocess 542 is a horizontal, destructive transformation that replaces a user-selected subprocess by another user-selected subprocess. It prompts the user for selecting the replacing subprocess from a list of subprocesses that the transformation obtains from the workspace. In the current implementation, this transformation connects the new subprocess only with control-flow edges.

Cycle removal 544 is a vertical, destructive, semantics preserving transformation that takes a process model with unstructured cycles, i.e., backward edges added to the flow, and produces a model with well-structured loops. The transformation leads to a model with a more technical flavor for many business users—therefore, it may be considered a vertical transformation. Cycle removal relies on the quality assurance framework 508. It can happen that it returns an only partially transformed model. In particular, cycles that spawn parallel branches often cannot be removed.

Join stop nodes 546 and Merge stop nodes 548 are horizontal and destructive transformations described in the detailed description of the invention. While Merge stop nodes is semantics preserving, Join stop nodes is not due to the semantics of these modeling elements.

Toggle fork/decision 550 is a horizontal, destructive transformation that simply flips a selected fork into a decision and vice versa. This version is useful during the editing process, e.g., when correcting modeling errors. However, it can easily introduce control-flow errors. A more sophisticated version would rather transform process fragments of sequential branching behavior into fragments of parallel behavior and vice versa, which requires a combination with quality assurance.

The treatment of data flow in transformations may be observed in the Assign data container 552 transformation, which is a vertical, destructive transformation that takes a model with control flow and refines it into a model with data flow. It may also be applied to models with mixed control and data flow. The transformation leads to a changed interface of model elements.

As described above, the model transformation processes provide benefits to the business modeling application 500 in terms of the speed at which transformations are executed, as well as usability. The differences between transformations and normal editing commands are transparent to the user running the transformations, because they see the result of the transformation immediately without the need to persist the transformed models.

In terms of usability, the transformations are easy to apply and significantly reduce the editing effort for the user. Model transformations may reduce lengthy and error-prone manual editing operations to a few clicks. For example, manually performing the join and merge stop nodes transformations in the above example scenario takes 42 mouse clicks. Automating the transformation still requires the user to select the set of nodes (two times three clicks), but then the model is updated with a single mouse click. Transformations are easily applicable by business users to automate complicated editing steps. By linking them to quality assurance capabilities 508 added to modeling tools, the transformations can be made “intelligent” and help users to preserve or re-establish the correctness of their models when going through a sequence of refinement and refactoring operations. The set of implemented transformations may significantly increase user productivity as they raise the abstraction level of the model-editing palette from a “picture drawing” tool to a level of supporting real business process modeling.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for combining quality assurance and model transformations in a business-driven development environment, comprising:
a host system executing a business modeling application;
a transformation framework executing on top of the business modeling application, the transformation framework including a transformation programming interface;
a quality assurance framework executing on top of the business modeling application, the quality assurance framework in communication with the transformation programming interface; and
a plurality of transformation plug-in tools in communication with the transformation programming interface;
wherein the transformation programming interface includes user-selectable options for model access and traversal, model element creation and removal, model element property editing, and model analysis; wherein the user-selectable options iteratively apply user-selected transformations, via one or more of the selected transformation plug-in tools, to at least a portion of a business process model resulting in a modified business process model that conforms to an information technology (IT)-based executable code; and
wherein the quality assurance framework performs single-entry-single-exit (SESE) fragment decomposition of the modified business process model, control-flow analysis of the modified business process model, and notification to the user of any detected error conditions, the notification presented to the user with the modified business process model via the transformation programming interface.

2. The system of claim 1, wherein the control-flow analysis is performed by the quality assurance framework using heuristics and state-space analysis applied to the SESE fragment decomposition, the method further comprising:
using results of the control-flow analysis to perform at least one of:
automatically modifying the user-selected transformations via the transformation framework; and
presenting the user-selected transformations to the user for modification via the transformation framework.

3. The system of claim 1, wherein the transformation plug-in tools include transformations for:
aggregating stop nodes;
reordering branches;
replacing subprocesses;
toggling forks or decisions; and
cycle removal.

4. The system of claim 1, wherein the transformation framework includes a palette registry with user-selectable icons for implementing transformations of the business process model.

5. The system of claim 1, wherein the control-flow analysis checks for control-flow errors in the modified business process model by analyzing each of the SESE fragments in isolation, whereby each control-flow error is local to a specified SESE fragment.
